(19) United States
(12) Patent Application Publication
(10) Pub. No.: US 2013/0144598 A1
(43) Pub. Date: Jun. 6, 2013

(54) TRANSLATION DEVICE, TRANSLATION METHOD AND RECORDING MEDIUM

(71) Applicant: Sharp Kabushiki Kaisha, Osaka (JP)

(72) Inventor: Takeshi KUTSUMI, Osaka (JP)

(73) Assignee: SHARP KABUSHIKI KAISHA, Osaka (JP)

(21) Appl. No.: 13/691,994

(22) Filed: Dec. 3, 2012

(30) Foreign Application Priority Data
Dec. 5, 2011 (JP) 2011-266170

(51) Int. Cl. G06F 17/28

(52) U.S. Cl. CPC G06F 17/28
USPC 704/2

(57) ABSTRACT

A translation device includes a text obtaining section for obtaining a text of an original document written in a first language, a translation word obtaining section for obtaining translation words of a second language for each of words or collocations included in the text obtained by the text obtaining section, a decision section for deciding whether or not each of the words or the collocations is to be translated by comparing characters forming the words or the collocations with characters forming the translation words obtained by the translation word obtaining section, and an output section for outputting translation words of the words or the collocations based on a decision made by the decision section.

### CROSS-REFERENCE TO RELATED APPLICATIONS

This Nonprovisional application claims priority under 35 U.S.C.§119(a) on Patent Application No. 2011-266170 filed in Japan on Dec. 5, 2011, the entire contents of which are hereby incorporated by reference.

### FIELD

The present application relates to a translation device, a translation method and a recording medium for translating an original document in the first language into the second language.

### BACKGROUND

Conventionally, a technique of automatically translating a document written in a language into another language is known. In recent years, as a translation device using such a technique, a device has been devised that obtains a translation word for each word or collocation in an original document, instead of translating the entire text of the original document, and outputs the translation word near the original text.

Such a translation device generally includes a means for determining whether or not a word or collocation needs to be translated in accordance with a difficulty level and a use frequency of the word or collocation. The device prevents an output result from being complicated and ensures readability by not outputting a translation word for the word or collocation decided not to be translated.

Moreover, another translation technique between Japanese and Chinese has been devised that utilizes information regarding origins of Chinese characters, or Kanji (also referred to as Kanji characters), for a language using the characters such as Chinese and Japanese. For example, Japanese Patent Application No. 2006-309346 describes a Japanese-Chinese machine translation device that selects an appropriate Chinese translation word from more than one Chinese translation words corresponding to Japanese words based on an association for Kanji characters between Japanese words and Chinese words.

The translation device as described above that decides a necessity of translation in accordance with a difficulty level and a use frequency, however, causes such a problem that a word unnecessary to a learner may also be output and thus the output result may become complicated, since the difficulty level and use frequency for a word or collocation vary depending on a learner's mother tongue. This is particularly significant in translation of languages having a word or collocation including the same character.

For instance, FIG. 1 illustrates an example where a conventional translation device is used to translate Chinese into Japanese and output the result. As shown in FIG. 1, several Chinese words are translated and output by the conventional translation device based on the difficulty level and use frequency for a Chinese speaker. The word “ [symbol] ” in Chinese and the word “ [symbol] ” in Japanese, meaning “overseas,” are comprised of the same characters and have the same meaning. A Japanese speaker, therefore, can understand the meaning by looking at it even if the word is not translated. Thus, if a word is translated based on the difficulty level and use frequency for a Chinese speaker as described above, a number of translation words that are assumed to be unnecessary for a Japanese speaker may be output, causing a problem of a complicated output result which is not easily readable by a learner.

In addition, Chinese and Japanese have Kanji characters of the same origin but with different shapes. For example, as shown in FIG. 1, “ [symbol] ” in Chinese and “ [symbol] ” in Japanese, meaning “zoo” are comprised of characters of the exactly same origins but have significantly different shapes. A beginner of Chinese language tends to miss the fact that “ [symbol] ” and “ [symbol] ” are basically the same character, and thus needs the word “ [symbol] ” to be translated. A Japanese speaker who has been learning Chinese for a while, however, usually notices that “ [symbol] ” is the same character as “ [symbol] ” and “ [symbol] ” is the same character as “ [symbol] ” and does not need the word “ [symbol] ” [symbol] to be translated because he/she understands the meaning thereof without translation. Another example of Kanji characters having the same origin are “ [symbol] ” in Chinese and “ [symbol] ” in Japanese, one meaning of which is “to decide,” that have very similar shapes. Such a character does not need to be translated even for a beginner of Chinese. Accordingly, the necessity for translation depends on the learning level of a learner and/or the similarity in the shapes of characters. This requires criteria for the necessity of translation.

Furthermore, Japanese Patent Application Laid-Open No. 2006-309346 discloses a Japanese-Chinese machine translation device that determines a Kanji character in a word in Japanese has the same origin as a Kanji character in a word in Chinese, and selects and outputs a most appropriate word from several Chinese words which are candidates for translation words for a word in Japanese. This device, however, does not include a means for deciding the necessity for translation and treats the characters with the same origin both in Japanese and Chinese equally, not differently for their linkage levels depending on each character.

### SUMMARY

The present application has been devised in view of the above circumstances, and has an object to provide a translation device, a translation method and a recording medium that appropriately suppress an output of an unnecessary word to obtain a more readable output result in accordance with a learner's learning level and/or a degree of similarities among the Kanji characters.

A translation device according to the present application includes a text obtaining section for obtaining a text of an original document written in a first language, a translation word obtaining section for obtaining translation words of a second language for each of words or collocations included in the text obtained by the text obtaining section, a decision section for deciding whether or not each of the words or the collocations is to be translated by comparing characters forming the words or the collocations with characters forming the translation words obtained by the translation word obtaining section, and an output section for outputting translation words of the words or the collocations based on a decision made by the decision section.

In the present application, the translation device includes a text obtaining section, a translation word obtaining section, a decision section and an output section. The text obtaining section obtains a text of an original document in the first language. The translation word obtaining section obtains a translation word in the second language for each word or collocation included in the text. The decision section compares characters forming a word or a collocation with characters forming a translation word, to decide whether or not the word or collocation is translated as a whole. The output section outputs a translation word for the word or collocation based on a result of decision made by the decision section. By thus comparing each character forming a word or collocation in the first language with each character forming a translation word, for example, a translation word of a word or collocation having the same or similar character, if any, is not to be output. When translation is performed between, for example, Chinese and Japanese, or Spanish and Italian that respectively include words or collocations comprised of the same character, output of an unnecessary translation of words may appropriately be suppressed with a simple means.

The translation device according to the present application, wherein the first language and the second language are Chinese and Japanese, respectively, and the decision section decides that the words or the collocations are not to be translated when Kanji characters forming the words or the collocations are entirely identical to Kanji characters forming the translation words. Where the Kanji characters are Chinese characters used in Japanese writing, Chinese writing and the like. In the present application, the Kanji characters used in Japanese writing may be expressed as Japanese Kanji characters (or Japanese Kanji) and the Kanji characters used in Chinese writing may be expressed as Chinese Kanji characters (or Chinese Kanji).

In the present application, in a translation device performing parallel translation between Chinese and Japanese, the decision section decides that a word or collocation is not to be translated when Kanji characters forming the word or collocation and Kanji characters forming a translated word for the word or collocation are entirely the same. By thus comparing Kanji characters only, necessity for translation of a word or collocation can be determined.

The translation device according to the present application, wherein the decision section decides that the words or the collocations are not to be translated when Kanji characters forming the words or the collocations and Kanji characters forming the translation words have same code points in Unicode.

In the present application, when a code point in Unicode for each Kanji character forming a word or collocation is entirely the same as that of each Kanji character forming a translation word for the word or collocation, the decision section decides that the word or collocation is not to be translated. This can easily determine whether or not a word or collocation needs to be translated.

The translation device according to the present application, wherein the first language and the second language are Chinese and Japanese, respectively, the translation device includes a Kanji relation dictionary in which a Chinese Kanji character and a Japanese Kanji character corresponding to the Chinese Kanji character are stored in association with each other, and the decision section decides to translate the words or the collocations when Kanji characters forming the words or the collocations are not associated with Kanji characters forming the translation words based on the Kanji relation dictionary.

In the present application, the translation device performing translation between Chinese and Japanese includes a Kanji relation dictionary in which a Kanji character in Chinese is associated with a Kanji character in Japanese corresponding to the Chinese Kanji character. The decision section decides that a word or collocation is to be translated when a Kanji character forming the word or collocation is not associated with a Kanji character forming a translation word for the word or collocation based on the Kanji relation dictionary. By thus comparing only the relation between Kanji characters, a decision can be made for whether or not a word or collocation needs to be translated.

The translation device according to the present application, includes a Kanji similarity dictionary in which a degree of similarity between a Chinese Kanji character and a Japanese Kanji character corresponding to the Chinese Kanji character is stored; and a calculation section for calculating a word similarity indicating a degree of similarity between the words or the collocations and the translation words based on the Kanji similarity dictionary, when Kanji characters forming the words or the collocations are associated with Kanji characters forming the translation words, wherein the decision section decides that the words or the collocations are not to be translated when the word similarity calculated at the calculation section is equal to or larger than a predetermined threshold.

In the present application, the translation device includes a Kanji similarity dictionary and a calculation section. The Kanji similarity dictionary stores a degree of similarity between a Kanji character in Chinese to a Kanji character in Japanese corresponding to the Chinese Kanji character. When each Kanji character forming a word or collocation is associated with each character forming a translation word for the word or collocation, the calculation section calculates a word similarity indicating a degree of the similarity between the word or collocation and the translation word of the word or collocation based on the Kanji similarity dictionary. The decision section decides that the word or collocation is not to be translated when the word similarity calculated by the calculation section corresponds to a predetermined threshold or larger. Accordingly, a word similarity may be calculated based on the similarity of each Kanji character in a word or collocation to each Kanji character in a translation word, to decide whether or not the word or collocation needs to be translated.

The translation device according to the present application, wherein the calculation section calculates an average value of similarities between all Kanji characters forming the words or the collocations and all Kanji characters forming the translation words as the word similarity.

In the present application, the calculation section calculates an average value of similarities between all the characters forming a word or collocation and all the characters forming a translation word for the word or collocation as a word similarity. Thus, the word similarity can easily be calculated.

The translation device according to the present application, wherein the calculation section calculates a lowest value among degrees of similarity for all the Kanji characters forming the words or the collocations and all the corresponding Kanji characters forming the translation words as the word similarity.

In the present application, the calculation section calculates the lowest value among degrees of similarity between all the Kanji characters forming a word or collocation and all the Kanji characters forming a translation word for the word or collocation, as the word similarity. Thus, the word similarity can easily be calculated.

The translation device according to the present application, wherein the Kanji similarity dictionary stores the degree of similarity based on a shape of the Kanji character.

In the present application, the degree of similarity between Kanji characters is predetermined based on the shape of the Kanji character.

The translation device according to the present application, wherein the Kanji similarity dictionary stores the degree of similarity based on a ratio in a body face at which a region enclosed by an outline of the Kanji character occupies.

In the present application, the degree of similarity between Kanji characters is predetermined based on an area ratio of a Kanji itself to a body face in a font.

The translation device according to the present application includes a threshold changing section for accepting a change in the threshold, wherein the decision section decides whether or not the words or collocations are to be translated using the changed threshold.

In the present application, the percentage of a word or collocation to be translated can be varied by changing the threshold. Thus, an output result can be more readable by appropriately changing the threshold value in accordance with a learning level of the second language.

The translation device according to the present application, wherein the output section outputs an entire text of the original document and outputs the translation words in a vicinity of the words or the collocations decided to be translated at the decision section.

In the present application, the output section outputs the entire text of the original document and further outputs a translation word for a word or collocation, which is decided to be translated at the decision section, near the word or collocation. Thus, a translation word can be placed at a position at which the meaning of a word or collocation can more easily be understood.

The translation device according to the present application, wherein the output section outputs the translation words decided to be translated at the decision unit between lines in the original document while maintaining a layout of the original document.

In the present application, the output section outputs a translation word for a word or collocation, which is decided to be translated at the decision section, between lines of the original text, while maintaining the layout of the original text. Thus, a translation word can be placed at a position at which the meaning of the word or collocation can more easily be understood.

The translation device according to the present application, wherein the output section generates an original text layer in which the entire text of the original document is arranged and a translation word layer in which the translation words are arranged, synthesizes the generated original text layer and the translation word layer, and outputs the synthesized layers.

In the present application, an original text layer in which the entire text of the original document is placed as well as a translation word layer in which a translation word is placed are prepared independently from each other, so that the arrangement of a translation word with respect to the original text can easily be controlled.

The translation device according to the present application, wherein the output section outputs the words or the collocations decided not to be translated at the decision section with a sideline or an underline.

In the present application, the output section outputs a word or collocation decided not to be translated at the decision unit with a sideline or an under line. This can clearly show the word or collocation decided not to be translated.

A translation method according to the present application includes obtaining a text of an original document written in a first language, obtaining translation words of a second language for each of words or collocations included in an obtained text, deciding whether or not the words or the collocations are to be translated by comparing characters forming the words or the collocations with characters forming the translation words, and outputting translation words of the words or the collocations based on a decision.

In the present application, a text of an original document in the first language is obtained, a translation word in the second language for each of words or collocations included in the text is obtained, a character forming a word or collocation is compared with a character forming a translation word, whether or not each word or collocation is to be translated is decided, and a translation word for a word or collocation is output based on the result of the decision. Thus, each character forming a word or collocation in the first language is compared with each character forming a translation word, so as not to output a translation word having a character identical or similar to a corresponding word or collocation. When, for example, translation is performed for languages including a word or collocation having the same character, such as Chinese and Japanese, or Spanish and Italian, the output of an unnecessary word can appropriately be suppressed with a simple means.

A non-transitory computer readable medium storing a computer program for causing a computer to translate an original document written in a first language into a second language and to output a result of a translation, the computer program includes steps of causing the computer to obtain a text of the original document written in the first language, causing the computer to obtain translation words of the second language for each of words or collocations included in an obtained text, deciding whether or not the words or the collocations are to be translated by comparing characters forming the words or the collocations with characters forming the translation words, and causing the computer to output translation words of the words or the collocations based on a decision.

In the present application, a text of an original document in the first language is obtained, a translation word in the second language for each of words or collocations included in the text is obtained, a character forming a word or collocation is compared with a character forming a translation word, whether or not each word or collocation is to be translated is decided, and a translation word for a word or collocation is output based on the result of the decision. Thus, each character forming a word or collocation in the first language is compared with each character forming a translation word, so as not to output a translation word having a character identical or similar to a corresponding word or collocation. When, for example, translation is performed for languages including a word or collocation having the same character, such as Chinese and Japanese, or Spanish and Italian, the output of an unnecessary word can appropriately be suppressed with a simple means.

In the present application, a translation device, a translation method and a computer program are provided which can appropriately suppress an output of an unnecessary translation word and produces a more readable output result by comparing a character forming a word or collocation with a character forming a translation word, deciding whether or not each word or collocation is to be translated, and outputting a translation word for a word or collocation based on the result of decision.

The above and further objects and features of the invention will more fully be apparent from the following detailed description with accompanying drawings.

### BRIEF DESCRIPTION OF DRAWINGS

FIG. 1 illustrates an example where Chinese is translated into Japanese to be output by the conventional translation device;

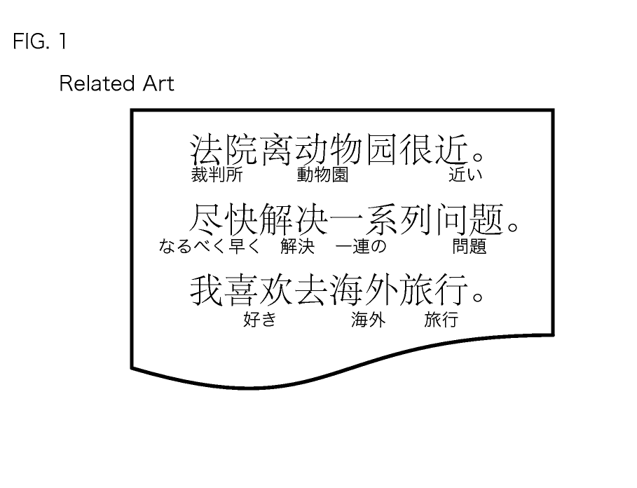

FIG. 2 is a block diagram showing the internal configuration of a translation device according to an embodiment of the present application;

FIG. 3 is a flowchart illustrating a procedure for processing executed by the translation device according to an embodiment of the present application;

FIG. 4 is a flowchart illustrating an example of a procedure for a translation word obtaining processing;

FIG. 5 illustrates an example of an image of an original document;

FIG. 6 is a conceptual view illustrating an example of contents of translation word data for the image of the original document shown in FIG. 5;

FIG. 7 shows an example of a Chinese-Japanese Kanji relation table;

FIG. 8 is a flowchart illustrating an example of a procedure for translation necessity decision processing;

FIG. 9 is a table illustrating a result of translation decision processing;

FIG. 10 is a flowchart illustrating an example of a procedure for processing of generating a document image with translation words;

FIG. 11 shows an example of a document image with translation words in the case where the threshold value is 0.40; and

FIG. 12 shows an example of a document image with translation words in the case where the threshold value is 0.70.

### DESCRIPTION OF EMBODIMENTS

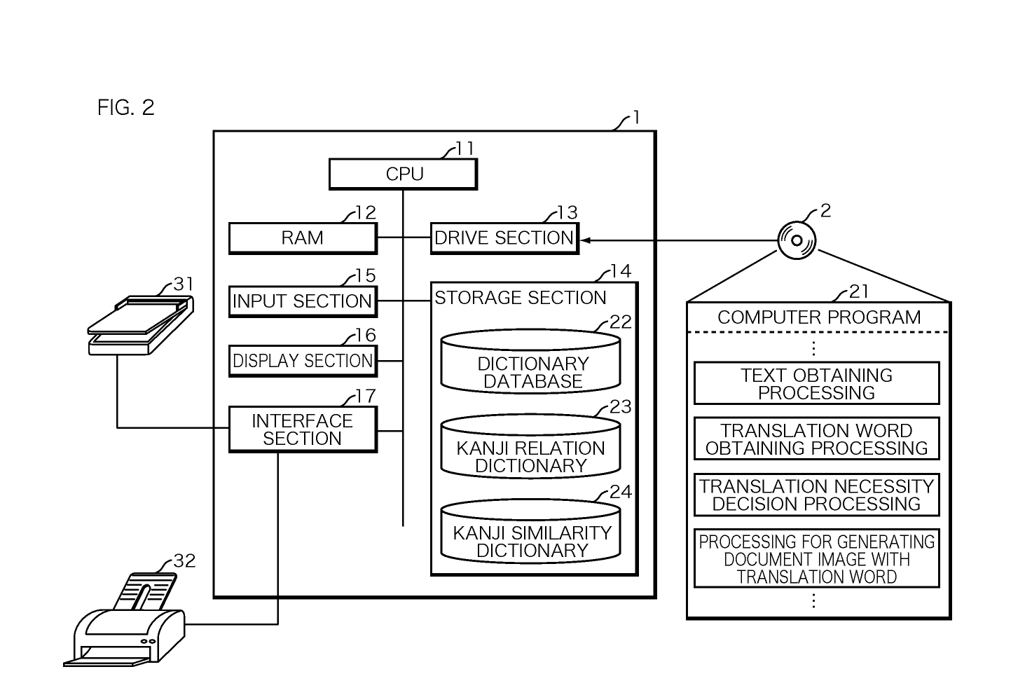

FIG. 2 is a block diagram showing the internal configuration of a translation device 1 according to an embodiment of the present application. The translation device 1 according to the present embodiment is configured with a general-purpose computer such as a PC or a server device, and includes a CPU 11 performing an arithmetic operation, a RAM 12 storing temporary information generated along with the arithmetic operation, a drive section 13 such as a CD-ROM drive reading information from a recording medium 2 such as an optical disk or a memory card, and a storage section 14 such as a hard disk. The CPU 11 makes the drive section 13 read a computer program 21 from the recording medium 2 of the present embodiment, and store the read computer program 21 in, for example, the storage section 14. The computer program 21 is loaded from the storage section 14 to the RAM 12 as required, while the CPU 11 executes necessary processing based on the loaded computer program 21. Note that the computer program 21 may alternatively be downloaded from an external server device (not shown) through a communication network such as the Internet or LAN and be stored in the storage section 14.

The storage section 14 stores therein a dictionary database 22 in which data required for natural language processing is recorded, a Kanji relation dictionary 23 in which Chinese Kanji characters and Japanese Kanji characters corresponding to the Chinese Kanji characters are respectively associated with each other, and a Kanji similarity dictionary 24 in which degrees of similarity between Chinese Kanji characters and Japanese Kanji characters are stored. The dictionary database 22 records information indicating a grammar of a language, a frequency of appearance for syntax, a meaning of a word and the like. The dictionary database 22, a Kanji relation dictionary 23 and a Kanji similarity dictionary 24 may be pre-stored in the storage section 14, or may be recorded in the recording medium 2 and read by the drive section 13 to be stored in the storage section 14.

The translation device 1 further includes an input section 15 such as a keyboard or a pointing device for inputting information including various types of processing instructions by the user's operation, and a display section 16 such as a liquid-crystal display showing various types of information. The translation device 1 includes an interface section 17 connected to an image reading device 31 and an image forming device 32. The image reading device 31 is a scanner such as a flatbed scanner or a film scanner, while the image forming device 32 is a printer such as an inkjet printer or a laser printer. It is noted that the image reading device 31 and image forming device 32 may integrally be formed.

The image reading device 31 optically reads an image recorded in an original text document, generates image data and sends the generated image data to the translation device 1, while the interface section 17 receives the image data sent from the image reading device 31. Furthermore, the interface section 17 sends the image data to the image forming device 32, which forms an image based on image data sent from the translation device 1.

The CPU 11 loads the computer program 21 of the present embodiment to the RAM 12 and executes the processing of the translation method of the present embodiment according to the loaded computer program 21. In the translation method, a text of the original document is obtained from the original document image generated by reading the image recorded in the original text document at the image reading device 31, a translation word for each word or collocation included in the obtained text is obtained, a character forming the word or collocation is compared with a character forming the obtained translation word for the word or collocation, whether or not translation is performed for each word or collocation is decided, and a document image with the translation word (hereinafter also referred to as a “translation-word-added document image”) in which a translation word for the word or collocation decided to be translated is generated and output. Here, a collocation is a phrase comprised of more than one words and having a unique meaning, which corresponds to an idiom, a common expression or the like.

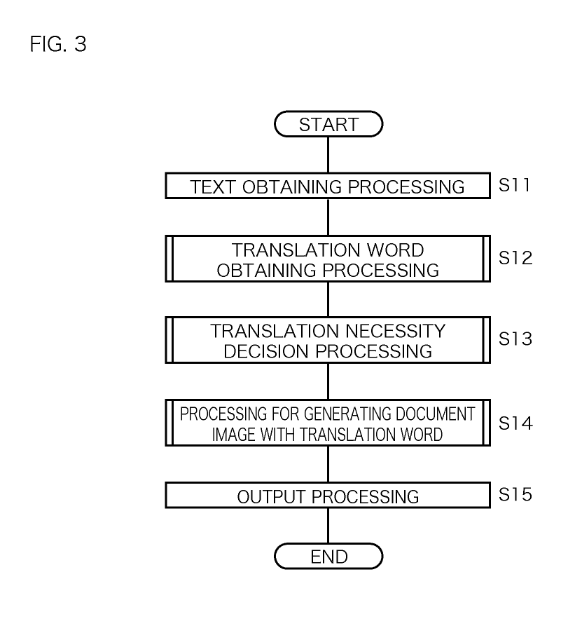

FIG. 3 is a flowchart illustrating a procedure for processing executed by the translation device 1 according to an embodiment of the present application. The CPU 11 executes the processing below according to the computer program 21 loaded to the RAM 12. In the present embodiment, an example is described where an original document is in Chinese while the translation thereof is in Japanese.

The translation device 1 performs text obtaining processing for obtaining an original text from an original document in which the original text in Chinese is written (step S11). At step S11, if the user instructs the processing at the input section 15 while the original document is placed on the image reading device 31, the CPU 11 sends an instruction for reading an image to the image reading device 31 through the interface section 17. The image reading device 31 reads an image recorded in the original document, generates image data and sends the generated image data to the translation device 1. The translation device 1 extracts a character region including a character from the original document image represented by the image data received through the interface section 17 and performs recognition of a character included in the character region and identification of a character position in the original document image using, for example, the conventional OCR (Optical Character Recognition) technique, to generate text data representing the content of the text in the original document and obtain a text of the original document in Chinese. Though the original document image read by the image reading device 31 is used as the original document in the present embodiment, it may also be an image or a text received through the interface section 17, or an image or a text pre-stored in the storage section 14, or may be a text input by the user through the input section 15. Note that, at step S11, when the OCR technique is utilized or when a text is obtained from the document with a format, the positional information and size information for each character is also obtained at the same time.

The CPU 11 subsequently executes translation word obtaining processing for obtaining a translation word for a word or collocation included in the text obtained by the text obtaining processing at step S11 described above (step S12).

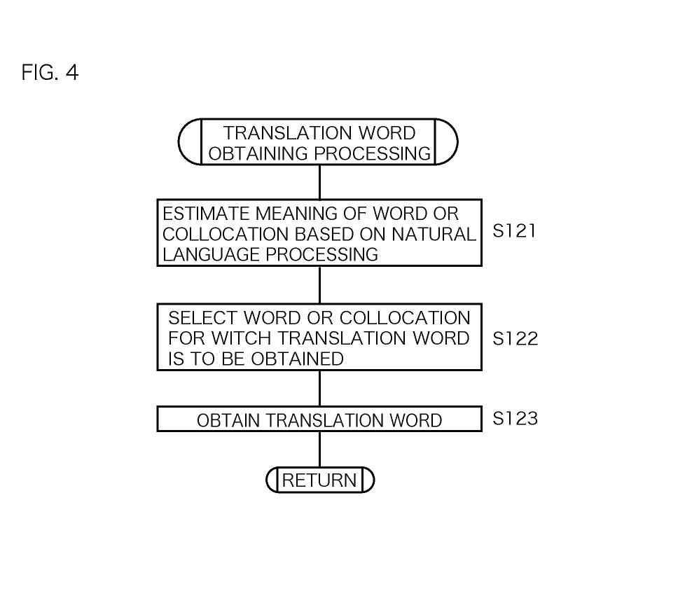

FIG. 4 is a flowchart illustrating an example of a procedure for translation word obtaining processing performed at step S12 in FIG. 3. The CPU 11 performs natural language processing on the text data representing the content of the text obtained at step S11, to perform processing of estimating the meaning of each word or collocation included in the text (step S121). At step S121, the CPU 11 performs natural language processing such as a morphologic analysis, a local syntax analysis and a part-of-speech estimation for a sentence represented by the text data, to identify a word or collocation comprised of more than one word, which is included in the sentence and estimate the meaning. The CPU 11 subsequently performs processing of selecting a word or collocation for which a translation word is to be obtained among words or collocations included in the sentence (step S122). For the data recorded in the dictionary database 22, a difficulty level or a use frequency is predetermined for each word or collocation, while the storage section 14 stores setting information in which the difficulty level or use frequency is set for each word or collocation in Chinese. At step S122, the CPU 11 selects a word or collocation for which the difficulty level or use frequency determined by the setting information is equal to or larger than a predetermined value, as a word or collocation which is to be translated.

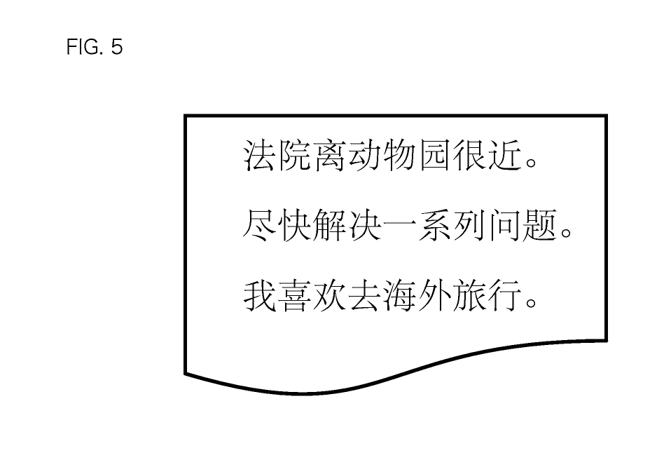

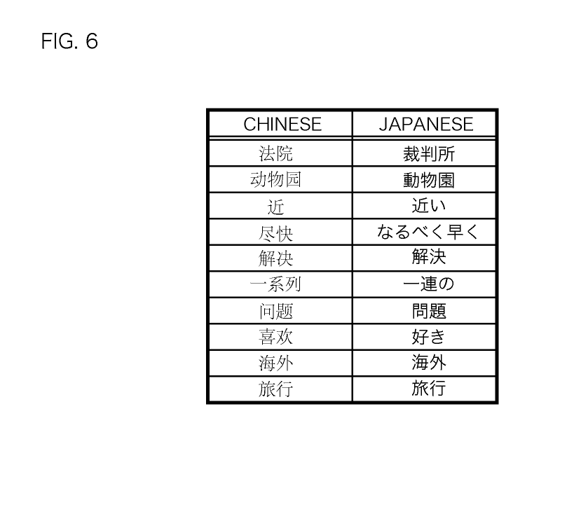

The CPU 11 performs processing for obtaining a translation word from the dictionary database 22 for each of the selected word or collocation (step S123). If there are more than one translation words, the CPU 11 obtains a translation word corresponding to a meaning estimated by natural language processing performed at step S121. The CPU 11 generates translation word data in which the word or collocation is associated with the obtained translation word, stores the data in RAM 12, and returns the processing to the main processing shown in FIG. 3. FIG. 5 illustrates an example of an image of an original document. FIG. 6 is a conceptual view illustrating an example of contents of translation word data for the image of the original document shown in FIG. 5. For the original document image shown in FIG. 5, words “ [symbol] ,” “ [symbol] ,” “ [symbol] ,” “ [symbol] [symbol] ,” “ [symbol] ,” “ [symbol] ,” “ [symbol] ,” “ [symbol] ,” “ [symbol] ” and “ [symbol] ” are selected as words or collocations which are to be translated and are respectively associated with translation words.

The CPU 11 compares a character forming a word or collocation with a character forming its translation word with respect to each of the words or collocations for which translation words are obtained, and executes the translation necessity decision processing for deciding whether or not the word or collocation is to be translated (step S13). At step S13, the CPU 11 compares a Chinese Kanji character in each word or collocation as shown in FIG. 6 with a Japanese Kanji character in the translation word thereof with reference to a Chinese-Japanese Kanji relation table based on the Kanji relation dictionary 23 and the Kanji similarity dictionary 24, to determine whether or not each word or collocation illustrated in FIG. 6 needs to be translated.

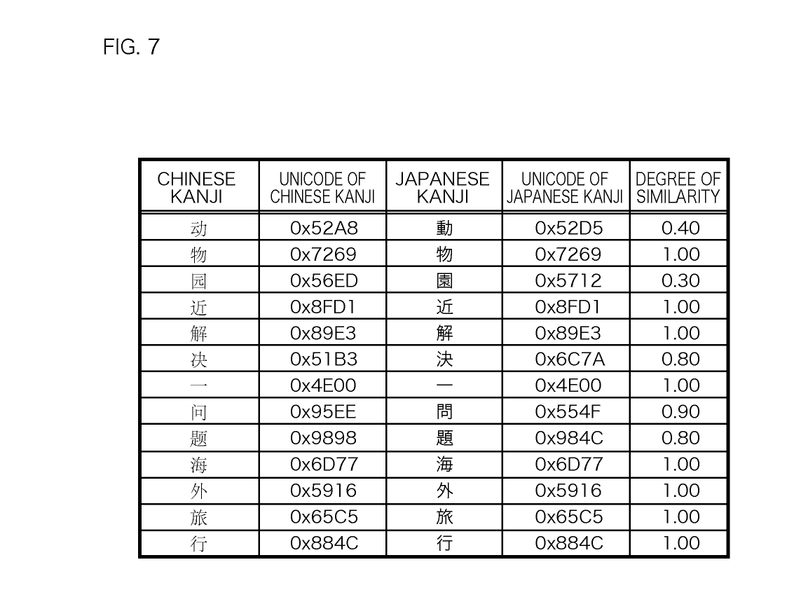

FIG. 7 shows an example of a Chinese-Japanese Kanji relation table. As illustrated in FIG. 7, in the Chinese-Japanese Kanji relation table, Chinese Kanji characters, Unicode of the Chinese Kanji characters, Japanese Kanji characters corresponding to the Chinese Kanji characters, Unicode of the Japanese Kanji characters and the degrees of similarity for the Chinese and Japanese Kanji characters are associated with one another. In the present embodiment, the degree of similarity between Kanji characters is a real numeral value between 0.00 and 1.00 inclusive, which is predetermined before executing translation as described below.

If a Chinese character is identical to a corresponding Japanese character, the degree of similarity is set as 1.00. Here, “identical character” means that Kanji characters have the same code point in Unicode. For example, “ [symbol] ” (meaning “object”) in Chinese and “ [symbol] ” in Japanese have the same code point in Unicode, they are recognized as the same Kanji character. Moreover, though “ [symbol] ” in Chinese and “ [symbol] ” in Japanese are little different in the shape of Kanji characters represented by fonts in the respective languages, these are recognized as the same Kanji character because they have the same code point in Unicode. If, however, a Chinese Kanji character is not the same as a corresponding Japanese Kanji character, the degree of similarity is determined based on the shape of Kanji and the learning level of a Japanese speaker. For example, the difference between “ [symbol] ” in Japanese and “ [symbol] ” in Chinese is smaller for a Japanese speaker than it appears because a shape similar to “ [symbol] ” is commonly used in informal handwriting for the character “ [symbol] ” in Japanese. Thus, a Kanji including the above-described character as a radical (“ [symbol] ” and “ [symbol] ” in FIG. 7 for example) is also provided with a degree of similarity in consideration of the circumstances described above.

Furthermore, there may be another method for giving a a degree of similarity as described below. The degree of similarity is predetermined according to a difference in shapes for each radical and is determined as a Kanji character taking these factors together into consideration with a certain method. Alternatively, characters in both languages are displayed with fonts having similar shapes (e.g., “SimHei” in Chinese and “MS Gothic” in Japanese) and an area ratio of a character itself to a body face (a design range of a character including a space such that characters are not in contact with each other when displayed) is obtained for each of the characters. The degree of similarity is regarded as higher when the difference or ratio of the values is smaller.

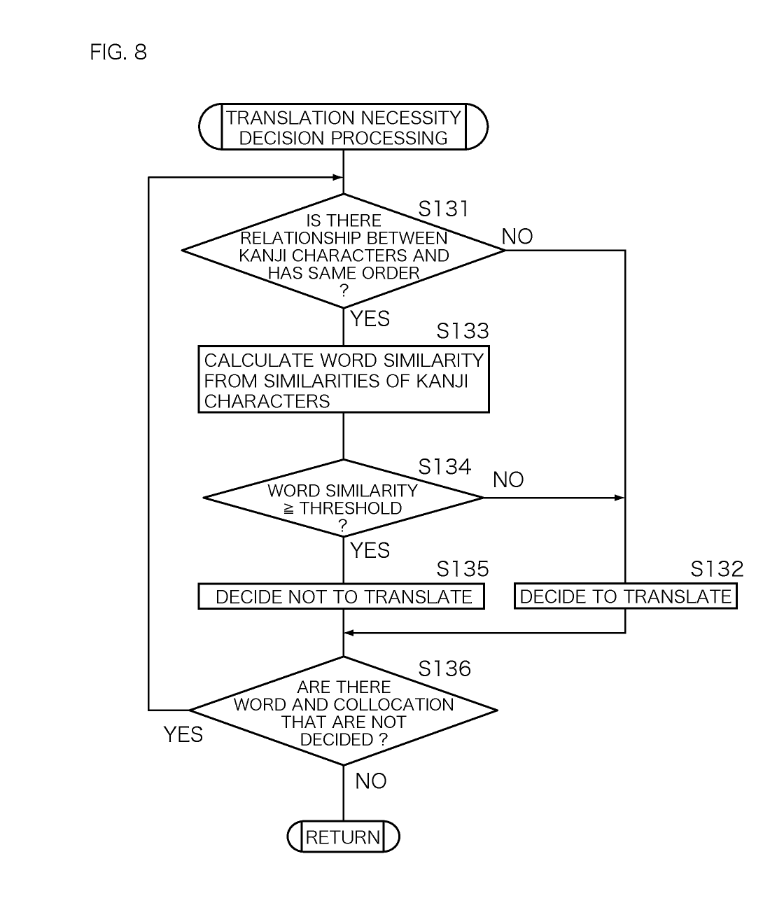

FIG. 8 is a flowchart illustrating an example of a procedure for translation necessity decision processing at step S13 in FIG. 3. The CPU 11 determines whether or not a Chinese Kanji character is associated with a Japanese Kanji character and has the same order in each Chinese word or collocation for which translation word is obtained, with reference to the Chinese-Japanese Kanji relation table illustrated in FIG. 7 (step S131). If a Chinese Kanji character is not associated with a Japanese Kanji character or does not have the same order (S131: NO), as in the case with “ [symbol] ” in Chinese and the corresponding “ [symbol] ” in Japanese, both meaning “court,” in FIG. 6 for example, it is determined that the word or collocation in Chinese is to be translated (step S132) and the processing proceeds to step S136.

If the CPU 11 determines that a Chinese Kanji character is associated with a corresponding Japanese Kanji character and has the same order (S131: YES), it refers to the Chinese-Japanese Kanji relation table shown in FIG. 7 to calculate a word similarity indicating a degree of similarity between the word or collocation and its translation word based on a degree of similarity for each Kanji character forming the word or collocation (step S133). At step S133, the CPU 11 obtains, for example, degrees of similarity for all the Kanji characters forming the word or collocation from the Chinese-Japanese Kanji relation table and calculates an arithmetic mean value for the obtained the degrees of similarity as the word similarities. For example, in the case of “ [symbol] ” in Chinese and the corresponding “ [symbol] ” in Japanese, the degree of similarity between “ [symbol] ” in Chinese and “ [symbol] ” in Japanese is 0.40, that between “ [symbol] ” in Chinese and “ [symbol] ” in Japanese is 1.0, and that between “ [symbol] ” in Chinese and “ [symbol] ” in Japanese is 0.30. By averaging out these values, the resulting word similarity is calculated as 0.57. Moreover, at step S133, the CPU 11 may obtain a degree of similarity of the Kanji character with the lowest value among the degrees of similarity for all the Kanji characters forming the word or collocation to be set as the word similarity. In such a case, the degree of similarity between “ [symbol] ” in Chinese and the corresponding “ [symbol] ” in Japanese will be 0.30.

The CPU 11 determines whether or not the word similarity calculated at step S133 is equal to or larger than a predetermined threshold (step S134), Though the predetermined threshold is set as 0.70 or 0.40 here, it can be preset as smaller and smaller as the user's skill in Chinese language becomes higher and higher. A change in the threshold may be accepted through, for example, the input section 15 of the translation device 1.

The CPU 11 decides that the word or collocation is “to be translated” (step S132) if it is determined that the word similarity is smaller than the predetermined threshold (S134: NO). If it is determined that the word similarity is equal to or larger than the predetermined threshold (S134: YES), the word or collocation is decided “not to be translated” (step S135). In the case of “ [symbol] ” in Chinese and the corresponding “ [symbol] ” in Japanese in FIG. 6 for example, it is determined that the word is “to be translated” when the threshold is set as 0.70 because the word similarity of 0.57 is less than the threshold of 0.70, whereas it is determined that the word is “not to be translated” when the threshold is set as 0.40 because the calculated word similarity of 0.57 is more than the threshold of 0.40.

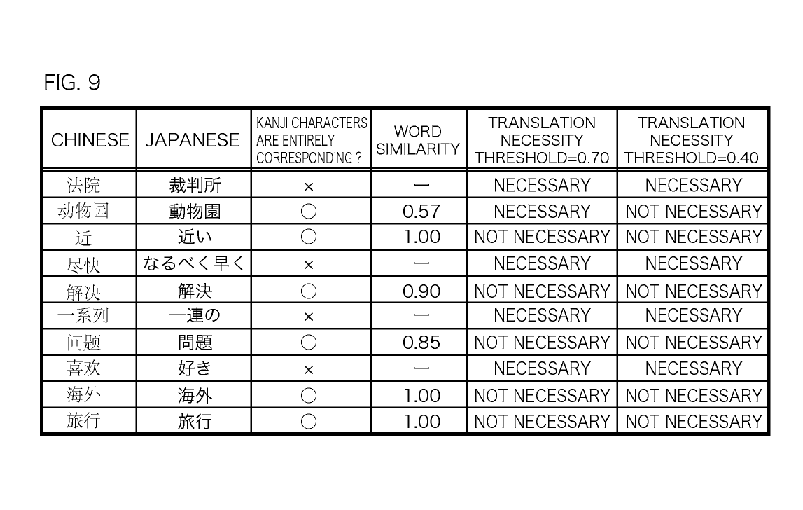

FIG. 9 is a table illustrating a result of the translation decision processing and shows results of decided translation necessity for each word or collocation shown in FIG. 6. The table illustrated in FIG. 9 records therein a word or collocation in Chinese, a translation word in Japanese for the word or collocation, a determined Kanji relation result, a calculated word similarity, a decision result of translation necessity when the threshold is set as 0.70, and a decision result of translation necessity when the threshold is set as 0.40. Since the Kanji characters “ [symbol] ,” “ [symbol] ,” and “ [symbol] ” are the same as the Kanji characters in the translation word here, they are decided not to be translated in both cases where the threshold is 0.70 and 0.40. As for the words “ [symbol] ,” “ [symbol] ,” “ [symbol] ” and “ [symbol] ” in Chinese, the Kanji characters forming each of the words or collocations are not associated with the Kanji characters forming the corresponding translation words. Thus, these words are decided to be translated when the threshold is 0.70 or 0.40. As for “ [symbol] ,” “ [symbol] ,” and “ [symbol] ,” on the other hand, the Kanji characters forming each of the words or collocations are associated with the Kanji characters forming translation words thereof while the calculated word similarities are 0.57, 0.90 and 0.85, respectively, necessity for translation is decided by comparing these levels with the predetermined threshold.

The CPU 11 determines whether or not there is a word or collocation for which the translation necessity has not been decided among the words or collocations for which translation words are obtained (step S136). If it is determined that there is a translation word for which translation necessity has not been decided among the obtained translation words (S136: YES), the CPU 11 returns the processing to step S131. If it is determined that there is no translation word for which translation necessity has not been decided among the obtained translation words (S136: NO), the CPU 11 returns the processing back to the main processing.

The CPU 11 subsequently decides the arrangement position of a translation word based on the result decided at step S13 and executes translation-word-added document image generating processing for generating a translation-word-added document image in which a translation word is arranged (step S14). At step S14, the CPU 11, for example, generates a translation-word-added document image by displaying the entire text of a Chinese original document and outputting a translation word for the word or collocation in the vicinity of the word or collocation decided to be translated. More specifically, the CPU 11 generates a translation-word-added document image in which a translation word is positioned between lines in the original document and a word or collocation decided not to be translated is provided with a sideline or an underline while maintaining the layout of the original document.

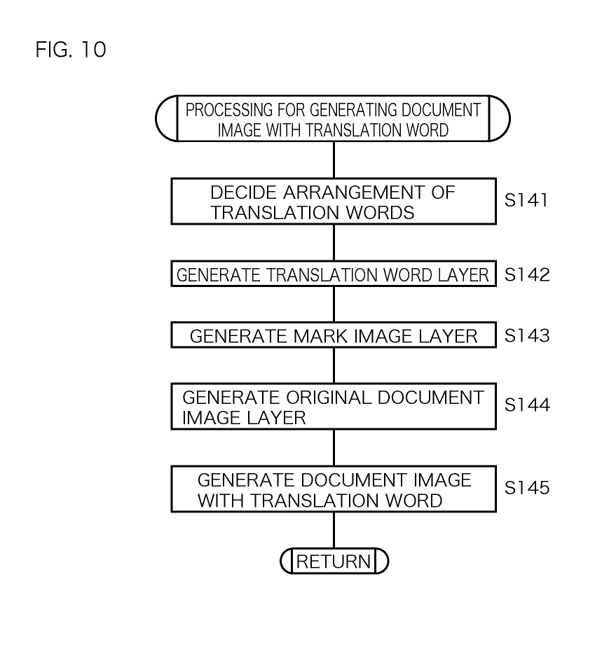

FIG. 10 is a flowchart illustrating an example of a procedure for processing of generating a translation-word-added document image performed at step S14 in FIG. 3. As shown in FIG. 10, the CPU 11 decides the arrangement of a translation word regarding the position, size and the like when positioning the translation word in the translation-word-added document image, for each translation word which is to be added to the translation-word-added document image (step S141). At step S142, the CPU 11 calculates a space between lines included in the document based on the positional information, size information and the like for a character obtained at step S 11, and decides the arrangement position and font size of the translation word.

The CPU 11 subsequently generates a translation word layer in which translation word data is positioned with the arrangement as decided at step S141 in a layer having the same size as the original document image (step S142). At step S142, the portion other than the translation word data in the generated translation word layer is made transparent. The CPU 11 then generates a mark image layer in which a line corresponding to an underline for a word or collocation decided not to be translated is positioned as a mark indicating the word or collocation that are not to be translated in the image having the same size as the original document image (step S143). At step S143, the portion other than the generated mark image layer is kept transparent.

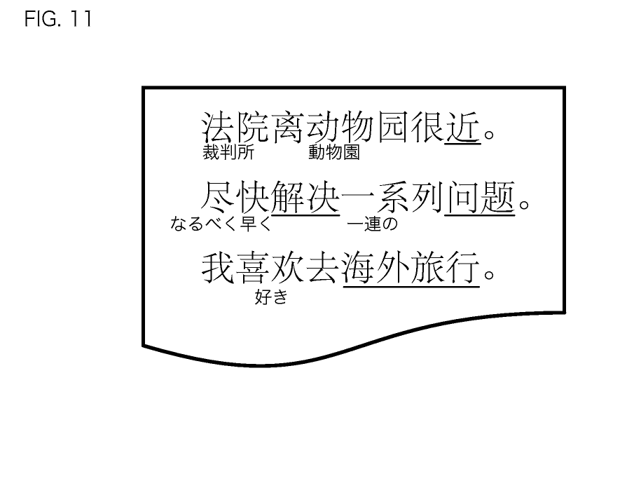

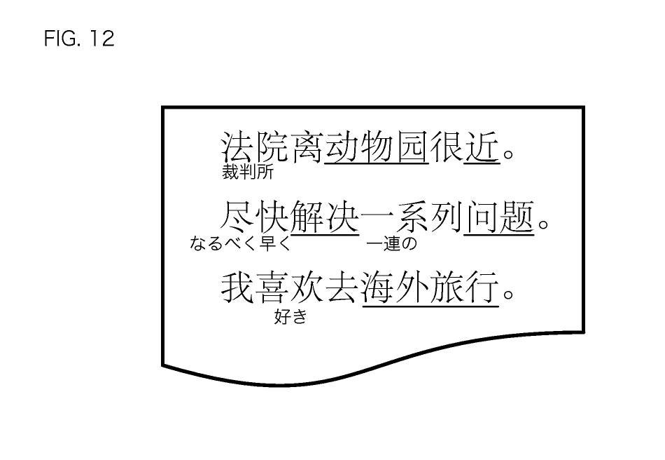

The CPU 11 generates an original document image layer in which an original document image is made to be an image layer (step S144). The CPU 11 subsequently places the mark image layer over the original document image layer to generate a translation-word-added document image (step S145), stores the image data representing the generated translation-word-added document image in the RAM 12 and returns the processing back to the main processing illustrated in FIG. 3. For example, at step S14, a translation-word-attached image is generated with an image of the PDF (Portable Document Format) form, while the CPU 11 generates each layer as a layer in the PDF form and places the generated translation word layer and mark image layer over the original document image layer, to generate a translation-word-added document image in the PDF form. FIGS. 11 and 12 illustrate examples of translation-word-added document images in the case where the threshold is 0.40 and 0.70, respectively. Each of the translation-word-added document images as shown in FIGS. 11 and 12 is a translation-word-added document image generated by placing the translation layer and mark image layer described above over the original document image shown in FIG. 5.

The CPU 11 then sends image data representing the translation-word-added document image from the interface section 17 to the image forming device 32, performs output processing for causing the image forming device 32 to form a translation-word-added document image based on the image data (step S15) and terminates the translation processing of the present embodiment. Note that, in the present embodiment, processing of displaying the translation-word-added document image on the display section 16 or storing the image data representing the translation-word-added document image in the storage section 14 may also be performed instead of the processing for forming the translation-word-added document image at step S15.

In the present embodiment, each character forming a word or collocation in the original text is compared with each character forming a translation word, to decide whether or not the word or collocation needs to be translated. If, for example, each character forming the word or collocation in the original text is the same as or similar to each character forming the translation word thereof, it can be set that the word or collocation does not need to be translated. The present embodiment can also be applicable to parallel translation of languages including a word or collocation comprised of the same character, such as Spanish and Italian, for example, other than Chinese and Japanese as described above.

While the embodiment described above showed an example where the original text of Chinese is translated into Japanese, it can also be applied to the case where the original text of Japanese is translated into Chinese. Moreover, though an example was described where simplified Chinese is used, it can also be applied to traditional Chinese.

Furthermore, in the embodiment described above, an example was shown where the present embodiment is applied to a document in horizontal writing. The present embodiment can, however, also be applied to a document in vertical writing. For example, the processing according to the present embodiment may also be executed with respect to a document in a vertical writing in Japanese, where a translation word may be positioned between lines and at the right side in the vicinity of a word or collocation.

While the embodiment described above illustrated a form where the translation device 1 has the internal storage section 14 which records therein the dictionary database 22, Kanji relation dictionary 23 and Kanji similarity dictionary 24, it is not limited thereto. The translation device 1 of the present embodiment may also take a form of executing the processing according to the present embodiment using an external dictionary database, Kanji relation dictionary or Kanji similarity dictionary. For example, a dictionary database or the like may be stored in a server device outside the translation device 1, and the translation device 1 may execute the processing according to the present embodiment by reading out necessary data from the external dictionary database or the like as needed.

What is claimed is:

1. A translation device, comprising:
a text obtaining section for obtaining a text of an original document written in a first language;
a translation word obtaining section for obtaining translation words of a second language for each of words or collocations included in the text obtained by the text obtaining section;
a decision section for deciding whether or not each of the words or the collocations is to be translated by comparing characters forming the words or the collocations with characters forming the translation words obtained by the translation word obtaining section; and
an output section for outputting translation words of the words or the collocations based on a decision made by the decision section.

2. The translation device according to claim 1, wherein
the first language and the second language are Chinese and Japanese, respectively, and
the decision section decides that the words or the collocations are not to be translated when Kanji characters forming the words or the collocations are entirely identical to Kanji characters forming the translation words.

3. The translation device according to claim 2, wherein
the decision section decides that the words or the collocations are not to be translated when Kanji characters forming the words or the collocations and Kanji characters forming the translation words have same code points in Unicode.

4. The translation device according to claim 1, wherein
the first language and the second language are Chinese and Japanese, respectively,
the translation device includes a Kanji relation dictionary in which a Chinese Kanji character and a Japanese Kanji character corresponding to the Chinese Kanji character are stored in association with each other, and
the decision section decides to translate the words or the collocations when Kanji characters forming the words or the collocations are not associated with Kanji characters forming the translation words based on the Kanji relation dictionary.

5. The translation device according to claim 4, further comprising:
a Kanji similarity dictionary in which a degree of similarity between a Chinese Kanji character and a Japanese Kanji character corresponding to the Chinese Kanji character is stored; and
a calculation section for calculating a word similarity indicating a degree of similarity between the words or the collocations and the translation words based on the Kanji similarity dictionary, when Kanji characters forming the words or the collocations are associated with Kanji characters forming the translation words, wherein
the decision section decides that the words or the collocations are not to be translated when the word similarity calculated at the calculation section is equal to or larger than a predetermined threshold.

6. The translation device according to claim 5, wherein
the calculation section calculates an average value of similarities between all Kanji characters forming the words or the collocations and all Kanji characters forming the translation words as the word similarity.

7. The translation device according to claim 5, wherein
the calculation section calculates a lowest value among degrees of similarity for all the Kanji characters forming the words or the collocations and all the corresponding Kanji characters forming the translation words as the word similarity.

8. The translation device according to claim 5, wherein
the Kanji similarity dictionary stores the degree of similarity based on a shape of the Kanji character.

9. The translation device according to claim 5, wherein
the Kanji similarity dictionary stores the degree of similarity based on a ratio in a body face at which a region enclosed by an outline of the Kanji character occupies.

10. The translation device according to claim 5, further comprising:
a threshold changing section for accepting a change in the threshold; wherein
the decision section decides whether or not the words or collocations are to be translated using the changed threshold.

11. The translation device according to claim 1, wherein
the output section outputs an entire text of the original document and outputs the translation words in a vicinity of the words or the collocations decided to be translated at the decision section.

12. The translation device according to claim 11, wherein
the output section outputs the translation words decided to be translated at the decision unit between lines in the original document while maintaining a layout of the original document.

13. The translation device according to claim 11, wherein
the output section generates an original text layer in which the entire text of the original document is arranged and a translation word layer in which the translation words are arranged, synthesizes the generated original text layer and the translation word layer, and outputs the synthesized layers.

14. The translation device according to claim 1, wherein
the output section outputs the words or the collocations decided not to be translated at the decision section with a sideline or an underline.

15. A translation method, comprising:
obtaining a text of an original document written in a first language;
obtaining translation words of a second language for each of words or collocations included in an obtained text;
deciding whether or not the words or the collocations are to be translated by comparing characters forming the words or the collocations with characters forming the translation words; and
outputting translation words of the words or the collocations based on a decision.

16. A non-transitory computer readable medium storing a computer program for causing a computer to translate an original document written in a first language into a second language and to output a result of a translation, the computer program comprising the steps of:
causing the computer to obtain a text of the original document written in the first language;
causing the computer to obtain translation words of the second language for each of words or collocations included in an obtained text;
deciding whether or not the words or the collocations are to be translated by comparing characters forming the words or the collocations with characters forming the translation words; and
causing the computer to output translation words of the words or the collocations based on a decision.
